(19) United States
(12) Patent Application Publication
(10) Pub. No.: US 2018/0040988 A1
(43) Pub. Date: Feb. 8, 2018

(54) CONNECTOR

(71) Applicant: Allsmartlite Technology Co., Ltd., Shenzhen City (CN)

(72) Inventors: XIAOPING WANG, Shenzhen City (CN); MING-HAN PERNG, Shenzhen City (CN); CHIEN-HSING LAI, Shenzhen City (CN)

(21) Appl. No.: 15/229,128

(22) Filed: Aug. 5, 2016

(51) Int. Cl. H01R 13/6581; H01R 24/64

(52) U.S. Cl. CPC H01R 13/6581; H01R 24/64; H01R 2107/00

(57) ABSTRACT

A male connector includes an integrally formed metallic case, a number of sets of first and second ribs. The metallic case has an upper face, a lower face opposite to the upper face, and two opposing lateral faces between and connecting corresponding edges of the upper and lower faces. The sets of first ribs are disposed at intervals on the upper and lower faces, respectively. The sets of second ribs are disposed on the lateral faces, respectively, where each set of second ribs corresponds to one of the gaps outside and in-between the sets of first ribs. When the male connector described above is plugged into a female connector, the first and second ribs press an internal wall of the female connector and enhance connection reliability. The ribs also provide multiple blockades to shield interferences.

### BACKGROUND OF THE INVENTION

### (a) Technical Field of the Invention

The present invention is generally related to electrical connectors, and more particular to an integrally formed male connector having superior connection reliability and shielding performance.

### (b) Description of the Prior Art

Antenna is a viable element for mobile devices capable of wireless communications. Antenna however is easily susceptible to interference from environmental electromagnetic noises, especially when there is a connection to an outside connector. The connector is therefore often enclosed in a shielding metallic case so as not only to provide better protection to the connector but also to prevent its magnetic field from influencing other components.

Taking a male connector as example, when it is plugged into a female connector, its shielding case interlocks with that of the female connector while electrical contact is established between their internal conductors. However, the connection may be shaky as too large a gap may be present between the male and female connectors. This may lead to reduced operational life and may also produce Electro Magnetic Interference (EMI) or Radio Frequency Interference (RFI), thereby compromising the quality of signal transmission.

Republic of China, Taiwan, Patent No. M480793 teaches a male connector where the shielding case has an encircling rib so as to create a gapless enclosed space, so as to shield interference to signals.

However, there are still the following disadvantages.

Firstly, the connection to the female connector is still shaky and unreliable.

Secondly, EMI and RFI are still inevitable.

Thirdly, the encircling rib may indeed create an enclosed space but has little improvement to the unreliable connection problem.

### SUMMARY OF THE INVENTION

Therefore a major objective of the present invention is to provide a male connector whose metallic case is integrally formed so that the male connector has no crevice.

Another major objective of the present invention is to provide a male connector having alternately arranged ribs so as to enhance connection reliability and shielding performance.

To achieve these objectives, the male connector includes an integrally formed metallic case, a number of sets of first and second ribs. The metallic case has an upper face, a lower face opposite to the upper face, and two opposing lateral faces between and connecting corresponding edges of the upper and lower faces. The sets of first ribs are disposed at intervals on the upper and lower faces, respectively. The sets of second ribs are disposed on the lateral faces, respectively, where each set of second ribs corresponds to one of the gaps outside and in-between the sets of first ribs.

The sets of first and second ribs are not connected and are alternately arranged at intervals on the metallic case. When the male connector is plugged into a female connector, the first and second ribs press and contact the inner wall of the female connector, thereby enhancing connection reliability. The ribs at intervals also provide multiple blockades to shield interferences. In addition, the metallic case is integrally formed so that there is no crevice, achieving superior visual appearance and structural strength.

With the above descried structure, the present invention resolves the shortcomings of the prior art such as shaky connection, low reliability, susceptibility to short circuit, EMI and RFI.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a male connector according to a first embodiment of the present invention.

FIG. 2 is a perspective diagram showing the male connector of FIG. 1 from a different angle.

FIG. 3 is a profile diagram showing the male connector of FIG. 1.

FIG. 4 is a perspective diagram showing the male connector of FIG. 1 to be plugged into a female connector.

FIG. 5 is a perspective diagram showing the male connector of FIG. 1 plugged into a female connector.

FIG. 6 is a sectional diagram showing the male and female connectors along A-A line of FIG. 5.

FIG. 7 is a perspective diagram showing a male connecter according to a second embodiment of the present invention.

FIG. 8 is a perspective diagram showing a male connecter according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

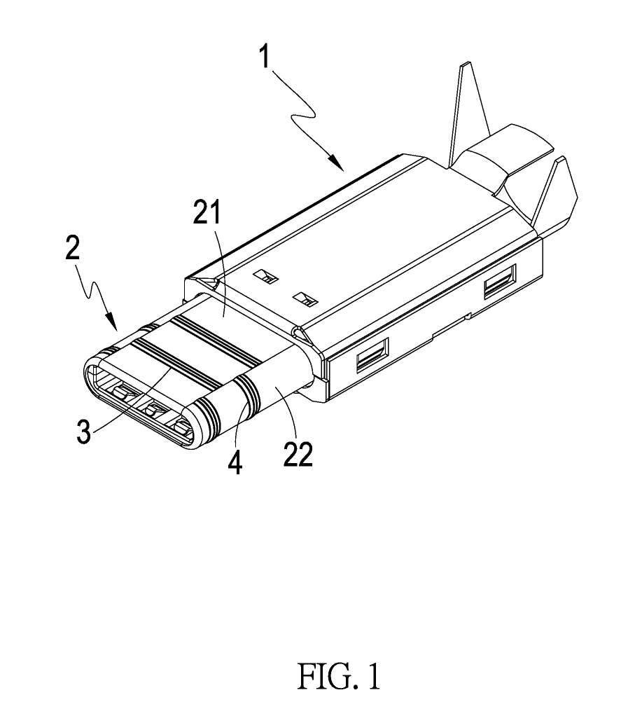

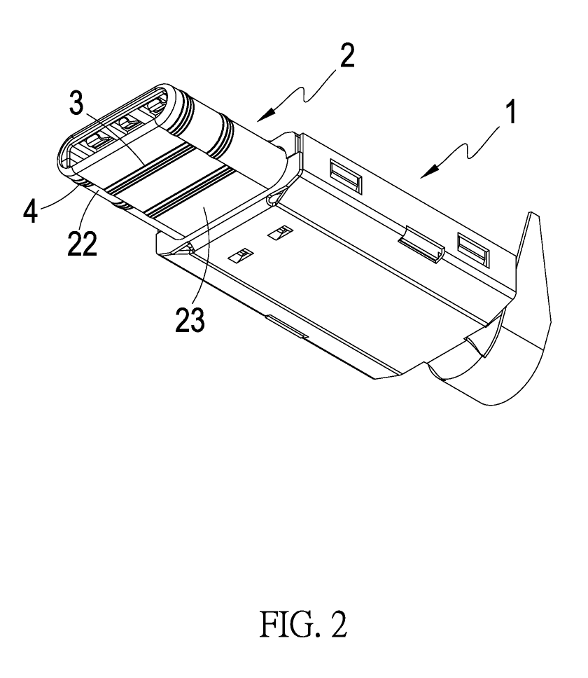

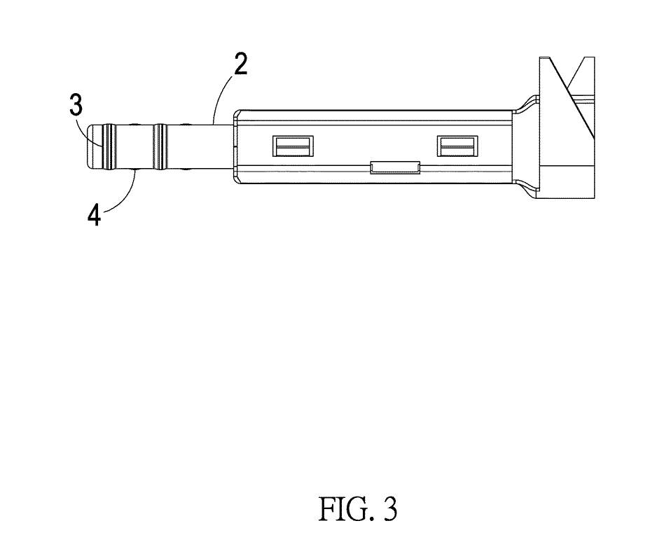

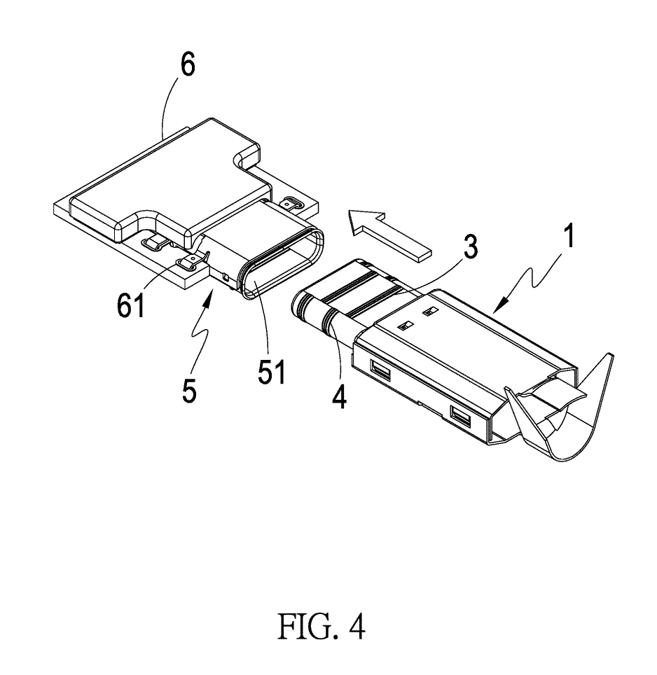

FIGS. 1 to 4 provide various views to a male connector according to a first embodiment of the present invention. As illustrated, the present invention teaches a male connector 1 that includes the following components.

An integrally formed, such as by die-casting, metallic case 2 has an upper face 21, a lower face 23 opposite to the upper face 21, and two opposing lateral faces 22 between and connecting corresponding edges of the upper and lower faces 21 and 23.

A number of sets of first ribs 3 are disposed at intervals on the upper and lower faces 21 and 23, respectively, thereby forming a number of gaps outside and in-between the sets of first ribs 3. Each set of first ribs 3 includes some first ribs 3 on the upper face 21 and some oppositely configured on the lower face 23.

Corresponding to each gap, a set of second ribs 4 are disposed on the lateral faces 22, respectively. Each set of second ribs 4 includes some second ribs 4 on a lateral face 22 and some oppositely configured on the other lateral face 22. The first and second ribs 3 and 4 are electrically connected a ground terminal 61 on a circuit board 6.

When the male connector 1 is plugged into a female connector 5, the first and second ribs 3 and 4 press against and contact an inner wall 51 of the female connector 5.

The male connector 1 described above may be integrally formed to achieve superior connection reliability and shielding performance. More detailed description is provided below.

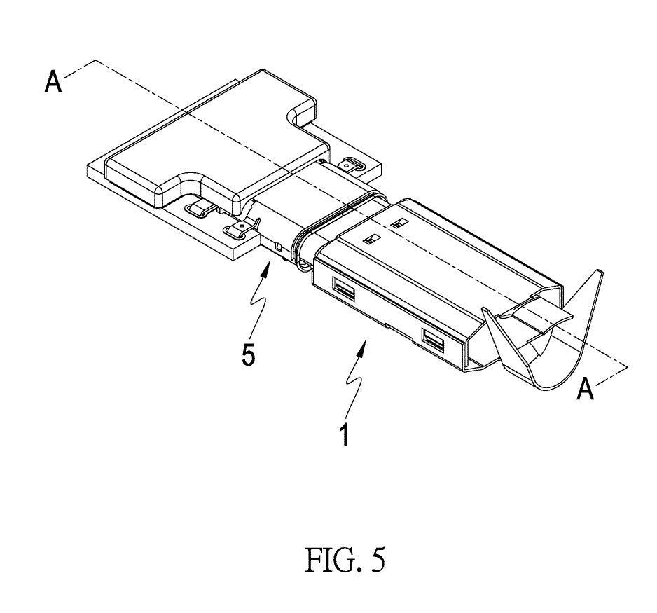

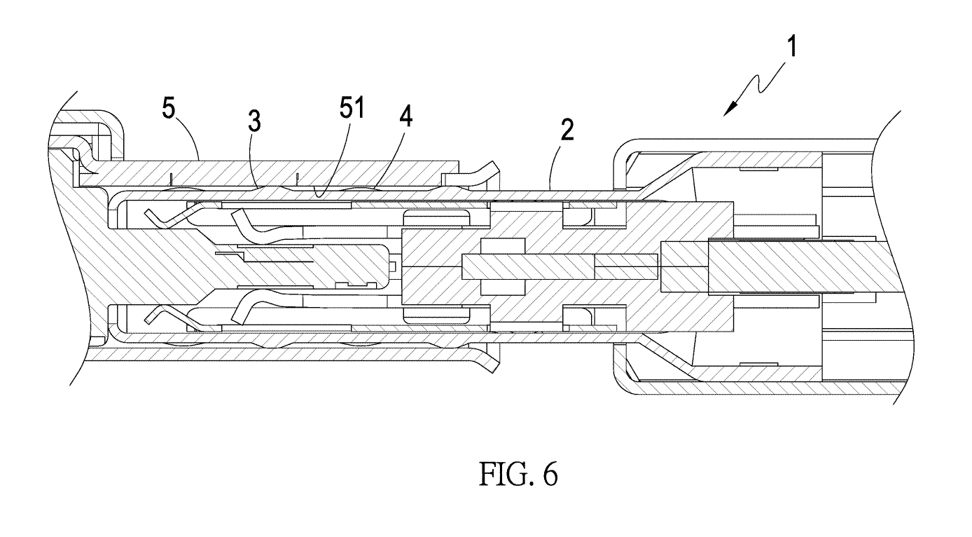

Additionally with FIGS. 5 and 6, which are a perspective view and a sectional view to the male connector 1 plugged into the female connector 5, the male connector 1, when integrally formed, does not have any crevice, and therefore not only is more visually appealing but also enjoys greater structural strength. On the other hand, the non-overlapping, alternately arranged sets of first and second ribs 3 and 4 achieve greater area of and more even contact with the inner wall 51 of the female connector 5, thereby enhancing connection reliability and avoiding short circuit. As the first and second ribs 3 and 4 are all connected to the ground terminal 61, the male connector 1 allows a greater current to flow through, achieving greater performance in, for example, charging.

Additionally, as the first and second ribs 3 and 4 are not overlapped or connected, the contact between the metallic case 2 and the interior of the female connector 5 does not achieve an entirely closed state. But the alternate arrangement of the first and second ribs 3 and 4 provides multiple blockades to noises, thereby achieving superior EMI or RFI shielding performance.

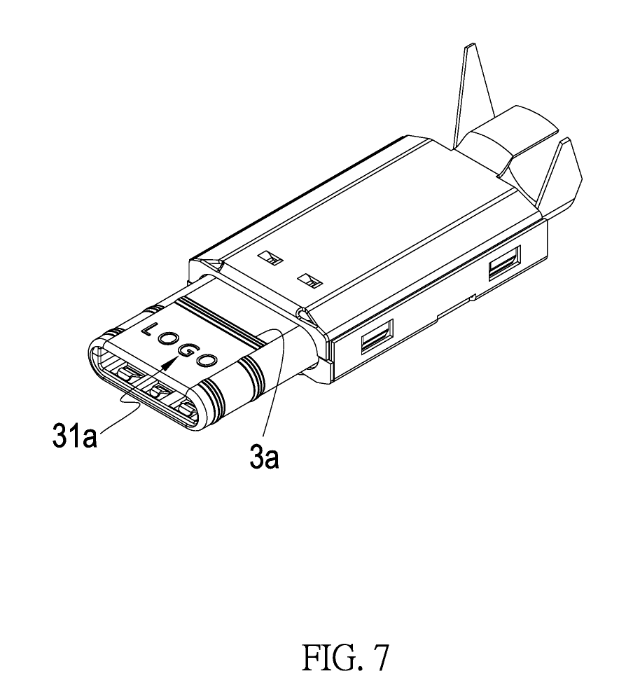

FIG. 7 shows a male connector according to a second embodiment of the present invention. As illustrated, the present embodiment is very much similar to the previous embodiment except that one of the sets of the first ribs 3a is replaced by a text or graphical first pattern 31a. In the present embodiment the first pattern 31a is a logo. As such, the male connector 1 may present different visual appearance and may provide identification or advertisement.

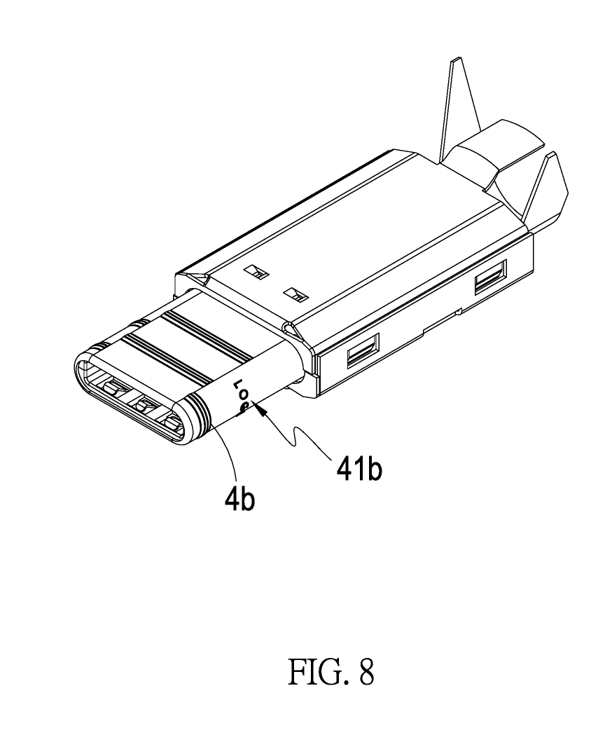

FIG. 8 shows another male connector according to a third embodiment of the present invention. As illustrated, the present embodiment is very much similar to the previous embodiments except that one of the sets of the second ribs 4b is replaced by a text or graphical first pattern 41b. In the present embodiment the second pattern 41b is a logo. As such, the male connector 1 may present different visual appearance and may provide identification or advertisement.

Compared to the prior art, the present invention has the following advantages.

Firstly, the metallic case 2 is integrally formed by die-casting, and therefore has a greater structural strength and superior appearance (no crevice).

Secondly, the first and second ribs 3 and 4 provide greater area of contact and more even contact, thereby achieving greater connection reliability.

Thirdly, the multiple ribs around the metallic case 2 provide multiple and continuous blockades to noises.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A male connector, comprising
an integrally formed metallic case having an upper face, a lower face opposite to the upper face, and two opposing lateral faces between and connecting corresponding edges of the upper and lower faces;
a plurality of sets of first ribs disposed at intervals on the upper and lower faces, respectively, with a plurality of gaps outside and in-between the sets of first ribs; and
a plurality of sets of second ribs disposed on the lateral faces, respectively, where each set of second ribs corresponds to one of the gaps.

2. The male connector according to claim 1, wherein, when the male connector is plugged into a female connector, the first and second ribs press against and contact an internal wall of the female connector.

3. The male connector according to claim 1, wherein the plurality of sets of first ribs comprises at least a first pattern.

4. The male connector according to claim 1, wherein the plurality of sets of second ribs comprises at least a first pattern.

5. The male connector according to claim 1, wherein the metallic case is formed by die-casting.

6. The male connector according to claim 1, wherein the first and second ribs are electrically connected to a ground terminal.

7. The male connector according to claim 6, wherein the ground terminal is configured on a circuit board.

8. The male connector according to claim 1, wherein each set of the first ribs comprises a plurality of first ribs on the upper face and a plurality of oppositely configured first ribs on the lower face; and each set of the second ribs comprises a plurality second ribs on one of the lateral faces and a plurality of second ribs oppositely configured on another lateral face.
